(19) United States
(12) Patent Application Publication
(10) Pub. No.: US 2022/0284281 A1
(43) Pub. Date: Sep. 8, 2022

(54) IMITATION LEARNING WITH FITTED Q ITERATION

(71) Applicant: INTERNATIONAL BUSINESS MACHINES CORPORATION, Armonk, NY (US)

(72) Inventors: Ryo Iwaki, Sumida-ku (JP); Takayuki Osogami, Yamato-shi (JP); Kohei Miyaguchi, Tokyo (JP)

(21) Appl. No.: 17/193,171

(22) Filed: Mar. 5, 2021

(51) Int. Cl. G06N 3/08; G06N 3/04

(52) U.S. Cl. CPC G06N 3/08; G06N 3/04

(57) ABSTRACT

Methods and systems for learning a policy model include determining an imitation learning expert policy. A policy model neural network is iteratively trained using the determined imitation learning expert policy, including modifying the policy model neural network at iteration to decrease a difference between an output of the policy model neural network and a target signal that is based on the determined imitation learning expert policy.

### BACKGROUND

The present invention generally relates to machine learning systems, and, more particularly, to the use of reinforcement learning combined with imitation learning, using fitted Q iteration for optimization.

Reinforcement learning may be used in systems with sequential decision-making. After each decision, the outcome of the decision is used to help weight the next decision. For example, an agent may be moving in an unknown environment, with each action bringing some reward or incurring some penalty. Using these rewards, reinforcement learning can help the agent reach a long-term goal, by optimizing its actions to provide the highest long-term reward.

### SUMMARY

A method for learning a policy model includes determining an imitation learning expert policy. A policy model neural network is iteratively trained using the determined imitation learning expert policy, including modifying the policy model neural network at iteration to decrease a difference between an output of the policy model neural network and a target signal that is based on the determined imitation learning expert policy.

A system for learning a policy model includes a hardware processor and a memory that stores a computer program product. When the computer program product is executed by the hardware processor, it causes the hardware processor to determine an imitation learning expert policy and to iteratively train a policy model neural network using the determined imitation learning expert policy, including modifying the policy model neural network at iteration to decrease a difference between an output of the policy model neural network and a target signal that is based on the determined imitation learning expert policy.

An autonomous vehicle training system includes a network interface that communicates with an autonomous vehicle, a hardware processor, and a memory that stores a computer program product. When the computer program product is executed by the hardware processor, it causes the hardware processor to determine an imitation learning expert policy, to iteratively train a policy model neural network using the determined imitation learning expert policy, including modifying the policy model neural network at iteration to decrease a difference between an output of the policy model neural network and a target signal that is based on the determined imitation learning expert policy, and to transmit parameters of the trained policy model neural network to the autonomous vehicle.

A vehicle control system includes a hardware processor; and a memory that stores a computer program product. When the computer program product is executed by the hardware processor, it causes the hardware processor to determine an imitation learning expert policy, to iteratively train a policy model neural network using the determined imitation learning expert policy, including modifying the policy model neural network at iteration to decrease a difference between an output of the policy model neural network and a target signal that is based on the determined imitation learning expert policy, to determine an action for a vehicle in an environment, using state information of the environment as input to the trained policy model neural network, and to issue an instruction to the vehicle to implement the determined action.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a vehicle within an environment that illustrates a comparison between reinforcement learning samples and imitation learning expert demonstrations, in accordance with an embodiment of the present invention;

FIG. 2 is a block/flow diagram of a method of iteratively training an imitation learning policy model, in accordance with an embodiment of the present invention;

FIG. 3 is a block/flow diagram of a method of determining an expert policy from a set of expert demonstrations, in accordance with an embodiment of the present invention;

FIG. 4 is a block diagram of a fitted Q iteration imitation learning system that trains an imitation learning policy model, in accordance with an embodiment of the present invention;

FIG. 5 is a diagram illustrating communications between a fitted Q iteration imitation learning system and a fleet of vehicles, in accordance with an embodiment of the present invention;

FIG. 6 is a diagram illustrating an exemplary high-level neural network model that may be used to implement a policy model, in accordance with an embodiment of the present invention;

FIG. 7 is a block/flow diagram of a method for remotely controlling a vehicle using an imitation learning policy model, in accordance with an embodiment of the present invention;

FIG. 8 depicts a cloud computing environment according to an embodiment of the present invention; and

FIG. 9 depicts abstraction model layers according to an embodiment of the present invention

### DETAILED DESCRIPTION

Reinforcement learning may be performed using batch or semi-batch optimization. In batch reinforcement learning, a policy may be learned from a fixed amount of training data. In semi-batch reinforcement learning, the policy may be updated after a certain amount of data is collected. Such updates may be performed infrequently, for example after a large amount of data is collected, to defer the cost of testing the updated policy before deployment. Tree-based fitted Q iteration (TFQI) may be used to perform optimizations for reinforcement learning systems.

If the demonstrations or policies of an expert are available, then reinforcement learning may be combined with imitation learning to improve sample efficiency. However, whereas TFQI builds a training set that includes an estimate of an optimal value, the value that the expert uses as the basis of their policy many not be available in imitation learning, making it difficult to apply TFQI to imitation learning systems.

To integrate imitation learning with TFQI optimization, the estimate of the optimal value may be determined based on a soft Bellman backup, with includes a prediction of a value of a successor state, and a penalty computed using an expert policy. Using this estimated value, TFQI can be used to optimize the reinforcement learning model using expert demonstrations.

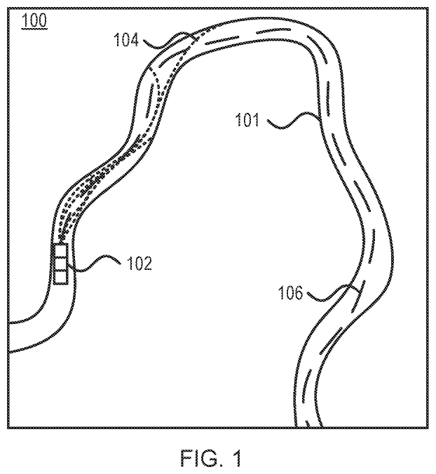

Referring now to FIG. 1, an example of reinforcement learning and imitation is shown. In this example, an agent 102 is given the task of navigating a course 100 along a path 101. In this example, the agent 102 may be understood as a robot or a self-driving vehicle, but it should be understood that the present principles apply to any appropriate reinforcement learning application. The vehicle 102 can turn to the left or right to stay within the path 101. The vehicle 102 succeeds at its task if it reaches the end of the path 101, and fails at its task if it intersects with the borders of the path 101 before reaching the end.

In reinforcement learning, the success and failure of the task can be used to inform a machine learning system within the vehicle 102. The machine learning system may update its policies to reflect the reward information, for example making the vehicle 102 less likely to perform actions that tend to result in failure, and more likely to perform actions that tend to result in success. These trials 104 are shown as dotted lines, and many such trials 104 may result in failure.

While reinforcement learning is very effective in some circumstances, it is difficult to obtain realistic trail data in circumstances where, such as in self-driving cars, it is not practical to allow the machine learning system to allow the system to learn by making numerous mistakes. Additionally, in some circumstances, the reward may be too infrequent for learning to be accomplished in a practical time frame. In further circumstances, it may be too difficult to create a reward function that produces good results from reinforcement learning. To help address these problems, imitation learning may be used.

Imitation learning may make use of demonstrations by an expert. In the context of the above example, a demonstration may include one or more known-successful courses 106, shown as a dashed line. In imitation learning, these demonstrations may reflect an expert policy πₑ, which is not available to the agent. That is, whatever reward function or motivations may have been that informed the expert, the agent has no direct knowledge about them. Instead, the agent uses the set of demonstrations to form its own policy π. During operation, the agent uses its policy π to make decisions.

For example, an agent in an environment may have a set of possible states [symbol] and a set of possible actions [symbol] . A transition model P(s′|s, a) describes the probability that an agent in the state s∈ [symbol] will move to state s′∈ [symbol] after performing the action a∈ [symbol] . The agent performs different actions based on its trained policy π. Meanwhile, a near-optimal policy πₑ is used by the expert to create the expert demonstrations, each of which may expressed as a set of trajectories, including pairs of states and actions that describe how the agent may move through the environment to reach a successful outcome. In some cases, the expert is available during training to generate additional demonstrations, or to evaluate the trained policy, as needed. In other cases, the expert generates the demonstrations before training occurs, and no further demonstrations may be made available.

The “expert” may be a human being, but may also be any other model or system. For example, a pre-trained model may be used to generate expert demonstrations for training a new model. In another example, a controller that has been intentionally designed, in contrast to something that has been trained, may be used. In the context of an autonomous vehicle system, for example, a self-driving vehicle that has been created without machine learning may represent the expert. The existing self-driving system may be used to generate a superior machine learning model. Regardless of what the expert is, it can be used to generate probabilities of an expert taking an action aₜ at state sₜ. If the expert cannot provide such a probability, then the estimated expert policy \hat{π}ₑ may be determined.

Fitted Q iteration provides batch mode reinforcement learning using a Q function that is defined on a state-action space of the agent. The Q function learns the value of actions for the agent to take using, e.g., a Markov decision process. The resulting Q function may provide maximum expected rewards for an action taken by the agent 102 in any state.

Fitted Q iteration provides an approximation of the Q function by iteratively extending an optimization horizon. At a first iteration, fitted Q iteration provides an approximation of the Q function using regression on the reward function. This process may then be iterated to obtain the approximate final Q function.

In some cases, the expert policy πₑ may be available. In other cases, the expert policy is not available, but an approximated policy \hat{π}ₑ may be used instead. In either case, the expert policy or the approximated policy may be used to perform fitted Q iteration on a system that uses imitation learning.

Although the example of a self-driving vehicle is addressed in particular, it should be understood that imitation learning may be used wherever expert information is available. Another exemplary application is in the control of a factory robot, where a particular motion is learned to achieve a particular fabrication task. In such a case, the expert demonstration may include guidance by a human, who maneuvers the factory robot through the process it will perform. Another example is in medical decision-making, where expert demonstrations of diagnoses and the prescription of responsive treatments may be generated by a doctor. Learning by fitted Q iteration may be accelerated by incorporating such expert knowledge.

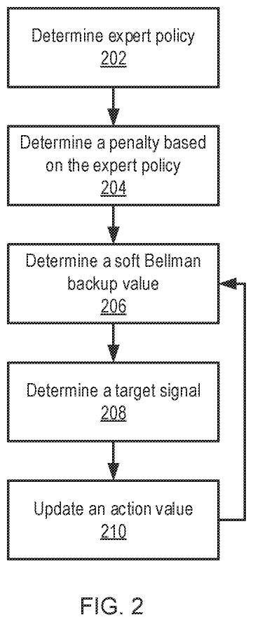

Referring now to FIG. 2, a method for training a machine learning model using reinforcement learning and imitation learning, using fitted Q iteration, is shown. Block 202 determines the expert policy πₑ. Alternatively, block 202 may approximate the expert policy \hat{π}ₑ using a set of expert demonstrations. The expert policy πₑ may reflect information about the system that the machine learning model is trying to learn, and may be provided without an explicit description of an underlying reward function.

Block 204 determines a penalty value, based on the expert policy or approximated expert policy. For example, this penalty value may be expressed as 1/ηlog(πₑ(aₜ|sₜ)), where aₜ is an action at a time t, sₜ is a state at time t, and η is a hyperparameter that determines the strength of the regularization.

Block 206 determines a soft Bellman backup value, which may be expressed as

$${r}_{t} + \frac{γ}{η} log {\sum }_{b ∈ 𝒜} exp ( {ηΨ}_{k} ( {s}_{t + 1} , b ) ) ,$$

where rₜ is a reward, γ is a discount factor, b is an action in action space [symbol] , and Ψₖ is a current estimate of an action value for data at time t in iteration k. The Ψₖ function approximates the true action value function Ψₑ^{*}, and is learned during training. This function may be implemented with any appropriate machine learning system, such as a neural network.

The soft Bellman backup value and the penalty value are combined in block 208 to generate a target signal yₜ=rₜ+γ/ηlog [symbol] exp(ηΨₖ(sₜ₊₁, b))+1/ηlog(πₑ(aₜ|sₜ)). This is an approximation of the true action value function, Ψₑ^{*}, which may be expressed as:

$${Ψ}_{e}^{*} ( s , a ) = ( s , a ) + \frac{γ}{η} {\sum }_{{s}^{′} ∈ 𝒮} 𝒫 ( {s}^{′} \vert s , a ) log {\sum }_{{a}^{′} ∈ 𝒜} exp ( η {Ψ}_{e}^{*} ( {s}^{′} , {a}^{′} ) ) + \frac{1}{η} log {π}_{e} ( a \vert s )$$

where [symbol] is the reward function, [symbol] is the state space, [symbol] is a transition probability between a state s′ and a state s from an action a.

Although the reward function is not directly accessible, a collection of samples {(sₜ, aₜ, sₜ₊₁, aₜ₊₁, rₜ)}ₜ₌₁^{T} may be available for reinforcement learning. In this setting, either the expert policy πₑ or the expert demonstrations aₜ^{e} may be used for some values of t. In the former case, the value of yₜ can be determined directly. In the latter case, then the estimated expert policy \hat{π}ₑ may be used.

Using the target signal yₜ, the action value Ψₖ may be updated in block 210. As noted above, the action value Ψₖ may be implemented as a machine learning model, such as a neural network. The weights of the neural network may be updated, as described in greater detail below, to decrease a deviation between the approximated action value Ψₖ and the true action value function Ψₑ^{*}. An error value δₑ between Ψₖ and Ψₑ^{*} may be determined using the approximation of Ψₑ^{*}, described above, to provide δₖ=yₖ−Ψₖ. Weight update values may be determined, using any appropriate optimization process, such as stochastic gradient descent.

Processing then returns to block 206, where the updated action value Ψₖ is used. This iteration continues until a stopping condition is met, at which point the trained machine learning model is output. The stopping condition may be, for example, a comparison between the error value δₖ and a predetermined positive threshold ϵ. When |δₖ|<ϵ, then the optimized parameters θ of the function approximator Ψₖ may be output.

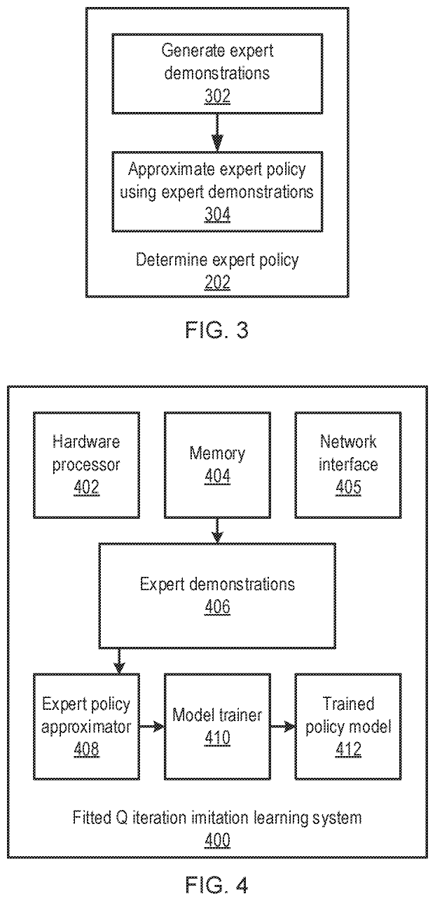

Referring now to FIG. 3, additional detail on the generation of the expert policy in block 202 is shown for situations where an expert policy is to be approximated. Block 302 receives a set of expert demonstrations aₜ^{e}. These demonstrations may be requested from an expert, or may be previously stored demonstrations. These expert demonstrations provide actions, from one time step t to the next. Any number of such demonstrations may be used. While it is difficult to predict how many demonstrations will be needed to provide adequate training results, the more demonstrations that are used, the better the results generally are. Using the demonstrations aₜ^{e}, supervised learning may be used to determine the approximated expert policy \hat{π}ₑ in block 304. For example, if the action is a discrete variable, then supervised classification learning methods may be appropriate. If the action is continuous, then supervised regression learning methods may be appropriate.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Referring now to FIG. 4, a fitted Q iteration imitation learning system 400 is shown. The system 400 includes a hardware processor 402 and a memory 404. The system 400 may further include a set of functional modules, each of which may be stored as software in the memory 404 and may be executed by the hardware processor to perform their respective functions. One or more of the functional modules may alternatively be implemented as one or more discrete hardware components, for example in the form of ASICs or FPGAs. A network interface 405 may be used to communicate with other devices by any appropriate wired or wireless communications medium and protocol.

The memory 404 may store expert demonstrations, relating to the interaction of an agent with an environment. As noted above, these expert demonstrations 406 may be generated prior to training, and may reflect some unknown expert policy. In some cases, additional expert demonstrations 406 may be generated as-needed, for example by referring to a human expert or by running a model that has already been trained. An expert policy approximator 408 uses the expert demonstrations to generate a policy, using the demonstrations. Model trainer 410 performs, for example, fitted Q iteration to bring the approximated policy model into line with the available demonstrations, outputting a trained policy model 412.

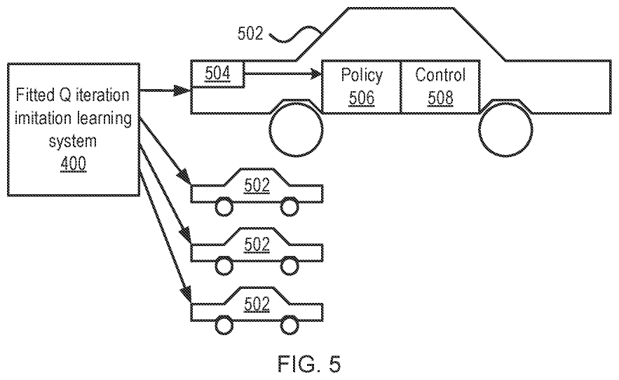

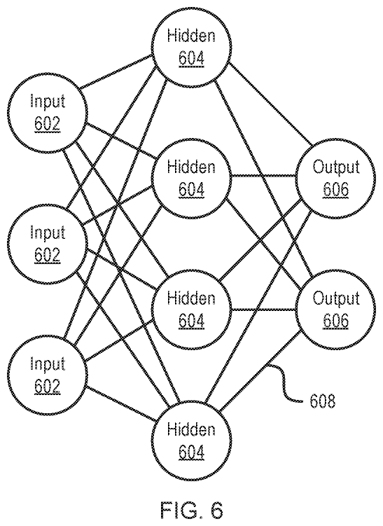

Referring now to FIG. 5, the fitted Q iteration imitation learning system 400 is shown in the context of a fleet of self-driving vehicles 502. Although the system 400 may be implemented within a vehicle 502, to make use of locally generated training information, the system 400 may also be implemented in separate system or a cloud computing system. The system 400 may use its network interface 405 to communicate with the vehicles 502. The system 400 outputs its policy model to each of a set of autonomous vehicles 502. These vehicles 502 each store the policy 506 on an on-board driving system, for example using an on-board computer.

Furthermore, although the vehicles 502 are depicted as being automobiles, it should be understood that any appropriate vehicle, robot, or device may be used instead. For example, the vehicles 502 may be robots that are used in a hazardous or remote environment. The vehicles 502 may operate independently, may controlled centrally, or may be controlled in either manner in accordance with circumstances.

During operation, the vehicles 502 use one or more sensors 504 to gather information about the scene around them. The sensors 504 on a vehicle 502 provide information about the current state (e.g., ‘s’) of the vehicle 502. The policy 506 is used to generate an action a based on the present state s. This action a is then implemented by the control system 508, which interfaces with the steering and speed of the vehicle. For example, the control 508 may control the direction of the vehicle's wheels and may furthermore control the vehicle's throttle and breaks. In this manner, the control 508 can implement the action a, controlling the vehicle's trajectory.

In a realistic scenario, the sensors 504 may detect the location of other vehicles and obstacles nearby the autonomous vehicle 502, as well as their relative velocities. The trained policy 506 may then generate an action a that avoids the obstacles and maintains a safe distance from other vehicles, speeding up, slowing down, changing lanes, and/or turning as needed. The demonstrations that are used to generate the policy 506 may have included demonstrations of behavior that is uncommon during normal driving conditions, but which nevertheless has a high risk of damage associated with it. For example, such a demonstration might include actions that respond to the detection of a vehicle driving in the wrong lane. Whereas a simple reinforcement learning system might not have enough exposure to such conditions to adequately, the use of expert demonstrations makes it possible to train the policy on a variety of situations which may be uncommon in practice, but which may have dramatic consequences.

It should be understood that the training that is performed by the fitted Q iteration imitation learning system 400 need not be performed only once, but may be updated in accordance with new information. For example, the vehicles 502 may communicate state information from the sensors 504, along with actual actions that are taken, whether by the control system 508 or by a human operator, to respond to that state information. This information can be used to generate further expert demonstrations for actions that produce satisfactory results in uncommon situations.

The policy 506 may be implemented as an artificial neural network (ANN). An ANN is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 6, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 602 that provide information to one or more “hidden” neurons 604. Connections 608 between the input neurons 602 and hidden neurons 604 are weighted, and these weighted inputs are then processed by the hidden neurons 604 according to some function in the hidden neurons 604. There can be any number of layers of hidden neurons 604, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 606 accepts and processes weighted input from the last set of hidden neurons 604.

This represents a “feed-forward” computation, where information propagates from input neurons 602 to the output neurons 606. Upon completion of a feed-forward computation, the output is compared to a desired output available from training data. The error relative to the training data is then processed in “backpropagation” computation, where the hidden neurons 604 and input neurons 602 receive information regarding the error propagating backward from the output neurons 606. Once the backward error propagation has been completed, weight updates are performed, with the weighted connections 608 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 608 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 608 may be implemented as resistive processing units (RPUs), generating a predictable current output when an input voltage is applied in accordance with a settable resistance.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

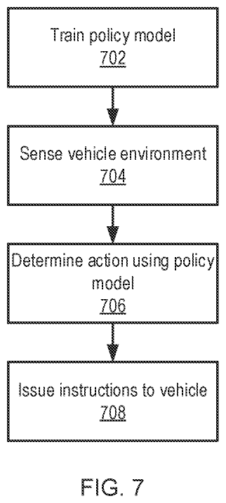

Referring now to FIG. 7, a method of remote control of a vehicle is shown. Rather than distributing the policy model parameters to the vehicles 502, as described above, the policy model may be maintained within the learning system 400, in which case the system 400 may further be used to issue instructions to the vehicles 502 via its network interface 405, and may similarly receive sensor information from the vehicles 502.

Block 702 trains the policy model, as described above. Block 704 senses the vehicle environment, for example using the sensors 504 that are positioned on a vehicle 502 or using other sensors that may be present in the environment. In some cases, multiple vehicles 502 may all sense the same environment, and their respective contributions may be combined to determine an overall state of the environment.

Block 706 determines an action for one or more vehicles 502 within the sensed environment, using the trained policy model. As noted above, this determination may be made at a location that is not within the vehicles 502, but may instead be in a separate installation or a cloud computing environment. Block 708 then issues instructions to a vehicle 502, for example using the network interface 405 of the system 400. The vehicle 502 uses this instruction to perform a maneuver within the environment.

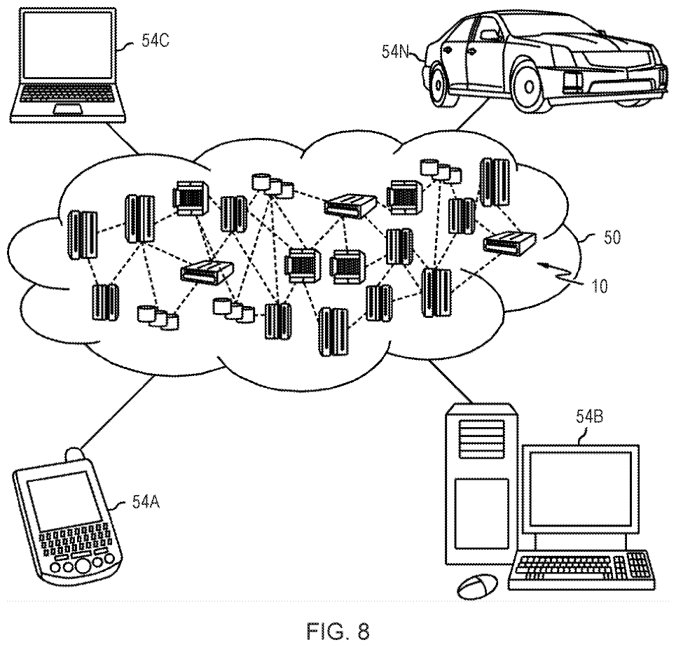

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

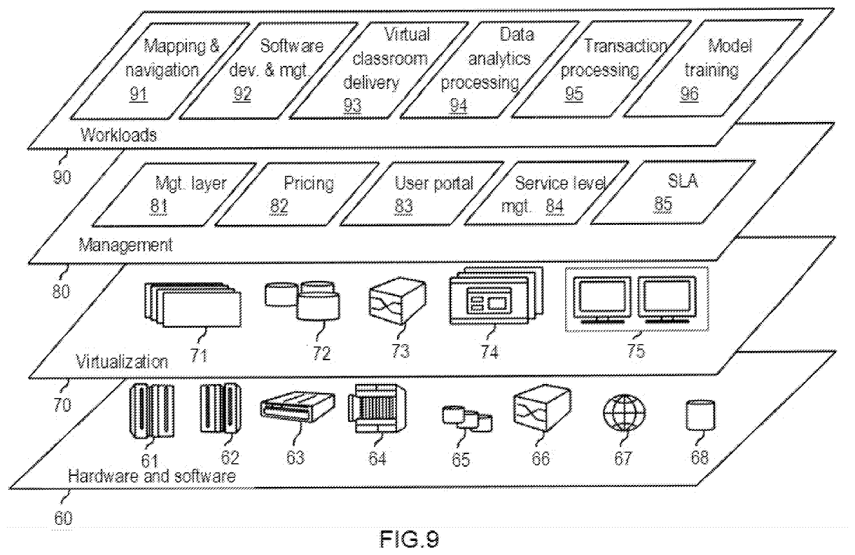

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom

education delivery 93; data analytics processing 94; transaction processing 95; and model training 96.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of imitation learning with fitted Q iteration (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer program product for learning a policy model, the computer program product comprising a computer readable storage medium having program instructions embodied therewith, the program instructions executable by a computer to cause the computer to:
determine an imitation learning expert policy; and
iteratively train a policy model neural network using the determined imitation learning expert policy, including modifying the policy model neural network at iteration to decrease a difference between an output of the policy model neural network and a target signal that is based on the determined imitation learning expert policy.

2. The computer program product of claim 1, wherein the program instructions further cause the computer to approximate the imitation learning expert policy using an expert demonstration.

3. The computer program product of claim 2, wherein the program instructions further cause the computer to use a supervised machine learning process to approximate the imitation learning expert policy.

4. The computer program product of claim 2, further comprising generating the expert demonstration from a pre-trained model.

5. The computer program product of claim 1, wherein the program instructions further cause the computer to perform fitted Q iteration with the imitation learning expert policy, where Q is a function that is defined on a state-action space.

6. A method for learning a policy model, comprising:
determining an imitation learning expert policy; and
iteratively training a policy model neural network using the determined imitation learning expert policy, including modifying the policy model neural network at iteration to decrease a difference between an output of the policy model neural network and a target signal that is based on the determined imitation learning expert policy.

7. The method of claim 6, wherein determining the imitation learning expert policy includes approximating the imitation learning expert policy using an expert demonstration.

8. The method of claim 7, wherein approximating the imitation learning expert policy uses a supervised machine learning process.

9. The method of claim 7, further comprising generating the expert demonstration from a pre-trained model.

10. The method of claim 6, wherein iteratively training the policy model neural network includes performing fitted Q iteration with the imitation learning expert policy, where Q is a function that is defined on a state-action space.

11. A system for learning a policy model, comprising:
a hardware processor; and
a memory that stores a computer program product, which, when executed by the hardware processor, causes the hardware processor to:
determine an imitation learning expert policy; and
iteratively train a policy model neural network using the determined imitation learning expert policy, including modifying the policy model neural network at iteration to decrease a difference between an output of the policy model neural network and a target signal that is based on the determined imitation learning expert policy.

12. The system of claim 11, wherein the computer program product further causes the hardware processor to approximate the imitation learning expert policy using an expert demonstration.

13. The system of claim 12, wherein the computer program product further causes the hardware processor to use a supervised machine learning process to approximate the imitation learning expert policy.

14. The system of claim 12, wherein the computer program product further causes the hardware processor to generate the expert demonstration from a pre-trained model.

15. The system of claim 11, wherein the computer program product further causes the hardware processor to perform fitted Q iteration with the imitation learning expert policy, where Q is a function that is defined on a state-action space.

16. An autonomous vehicle training system, comprising:
a network interface that communicates with an autonomous vehicle;
a hardware processor; and
a memory that stores a computer program product, which, when executed by the hardware processor, causes the hardware processor to:
determine an imitation learning expert policy;
iteratively train a policy model neural network using the determined imitation learning expert policy, including modifying the policy model neural network at iteration to decrease a difference between an output of the policy model neural network and a target signal that is based on the determined imitation learning expert policy; and
transmit parameters of the trained policy model neural network to the autonomous vehicle.

17. The autonomous vehicle training system of claim 16, wherein the computer program product further causes the hardware processor to approximate the imitation learning expert policy using an expert demonstration.

18. The autonomous vehicle training system of claim 17, wherein the computer program product further causes the hardware processor to use a supervised machine learning process to approximate the imitation learning expert policy.

19. The autonomous vehicle training system of claim 17, wherein the computer program product further causes the hardware processor to generate the expert demonstration from a pre-trained model.

20. The autonomous vehicle training system of claim 16, wherein the computer program product further causes the hardware processor to perform fitted Q iteration with the imitation learning expert policy, where Q is a function that is defined on a state-action space.

21. A vehicle control system, comprising:
a hardware processor; and
a memory that stores a computer program product, which, when executed by the hardware processor, causes the hardware processor to:
determine an imitation learning expert policy;
iteratively train a policy model neural network using the determined imitation learning expert policy, including modifying the policy model neural network at iteration to decrease a difference between an output of the policy model neural network and a target signal that is based on the determined imitation learning expert policy;
determine an action for a vehicle in an environment, using state information of the environment as input to the trained policy model neural network; and
issue an instruction to the vehicle to implement the determined action.

22. The vehicle control system of claim 16, wherein the computer program product further causes the hardware processor to approximate the imitation learning expert policy using an expert demonstration.

23. The vehicle control system of claim 17, wherein the computer program product further causes the hardware processor to use a supervised machine learning process to approximate the imitation learning expert policy.

24. The vehicle control system of claim 17, wherein the computer program product further causes the hardware processor to generate the expert demonstration from a pre-trained model.

25. The vehicle control system of claim 16, wherein the computer program product further causes the hardware processor to perform fitted Q iteration with the imitation learning expert policy, where Q is a function that is defined on a state-action space.
